(19) United States
(12) Patent Application Publication
(10) Pub. No.: US 2015/0208341 A1
(43) Pub. Date: Jul. 23, 2015

(54) Power Efficient Network with Network Controller

(71) Applicants: Parvez Syed Mohamed, Folsom, CA (US); Craig Joseph Mills, Davis, CA (US); Shaun Wakumoto, Roseville, CA (US)

(72) Inventors: Parvez Syed Mohamed, Folsom, CA (US); Craig Joseph Mills, Davis, CA (US); Shaun Wakumoto, Roseville, CA (US)

(21) Appl. No.: 14/417,059

(22) PCT Filed: Jul. 31, 2012
(86) PCT No.: PCT/US2012/049069

§ 371 Date: Jan. 23, 2015

(51) Int. Cl. H04W 52/02; H04L 12/26; H04L 12/24

(52) U.S. Cl. CPC H04W 52/0203; H04L 41/0893; H04L 43/08; H04W 88/14

(57) ABSTRACT

A non-transitory computer-readable medium for managing power consumption in a network of network devices is disclosed. The computer-readable medium stores instructions, that when executed by one or more processors, cause the one or more processors to perform certain operations. The operations include monitoring network data traffic, establishing a network power management policy based on the monitored data traffic, and enforcing the network power policy. The enforcing is carried out by centrally managing a powered state of a portion of the network based on power consumption criteria.

### BACKGROUND

Data networks route data traffic via a collection of network devices that take the form of, for example, routers, hubs and switches. Very large networks may involve hundreds or even thousands of network devices. To optimize network power efficiency, individual network devices often coordinate via network protocols such as the Spanning Tree Protocol (STP) and the like, to route data along paths between network devices. There are circumstances where it may be helpful to minimize network power consumption based on information gleaned by an entity external to the collection of network devices.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 illustrates an example of a network controller;

FIG. 2 illustrates an example of a network that employs the network controller of FIG. 1 with plural network devices;

FIG. 3 illustrates the network of FIG. 2 after redistributing traffic routing and changing port speeds;

FIG. 4 illustrates the network of FIG. 2, with selected ports of the network devices being disabled based on location of the ports in each device; and

FIG. 5 illustrates an example network that employs a network controller to selectively power down redundant links employed in link aggregation roles.

### DETAILED DESCRIPTION

Examples described herein provide methods and associated apparatus for allowing a network controller to monitor and carry out power management functions relating to a network of network devices to minimize power consumption in the network. By employing the centralized network controller to handle network power management operations, enhanced efficiencies and improved responsiveness may be realized.

According to one example, a non-transitory computer-readable medium for managing power consumption in a network of network devices is disclosed. The computer-readable medium stores instructions, that when executed by one or more processors, cause the one or more processors to perform certain operations. The operations include monitoring network data traffic, establishing a network power management policy based on the monitored data traffic, and enforcing the network power policy. The enforcing is carried out by centrally managing a powered state of a portion of the network based on power consumption criteria.

According to a further example, a network is disclosed. The network includes a plurality of network devices and a network controller in communication with the network devices. The network controller includes a network traffic monitor, and a power manager. The power manager controls a powered state of a portion of the network based on information from the network traffic monitor and an established network power management policy.

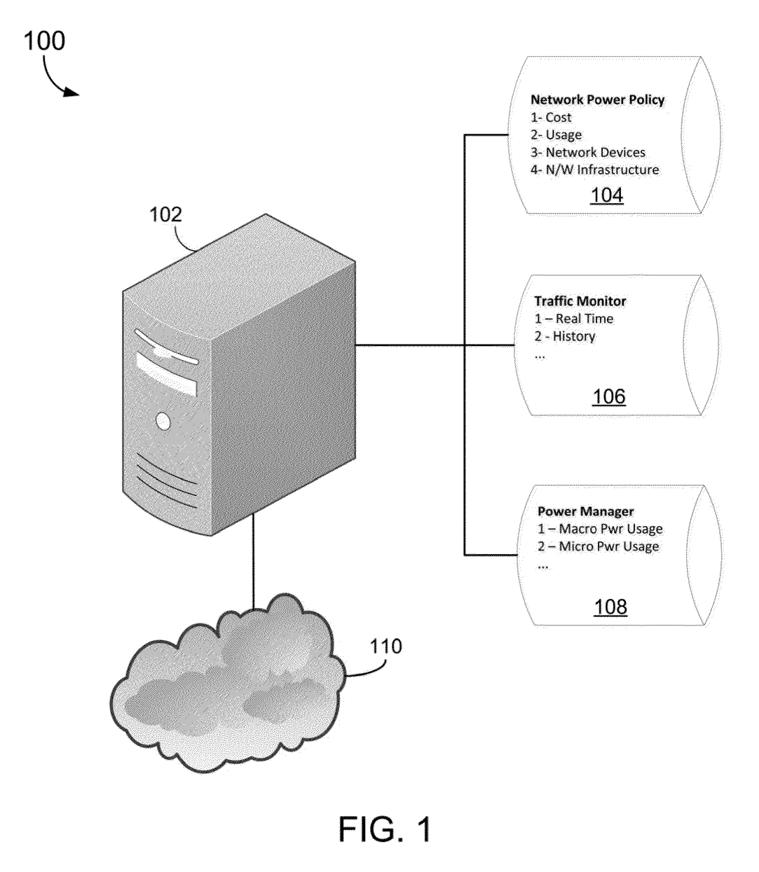

Referring now to FIG. 1, one example of a network controller, generally designated 100, and in the form of a general purpose computer 102, includes software and hardware resources sufficient to monitor and control a data network 110 compatible with, for example, IP layer protocols IPv4 and/or IPv6. The general purpose computer 102 may include hardware resources including one or more processors, memory and peripheral devices (not shown) as is well-known in the art. In one specific example, the computer 102 is responsive to a variety of software modules or applications such as a network power policy 104, a data traffic monitor 106, and a power manager 108. The network controller 100 interfaces with the data network 110, such as a local area network (LAN), wide area network (WAN) or, for example, the Internet.

Further referring to FIG. 1, the network power policy 104 generally establishes a set of rules that are programmed into the controller 100 in an effort to establish a high-level goal of reducing power consumption. For example, the policy might set in place rules to reduce power based on cost criteria, or utilization criteria. Other rules, for example, might define to what level the power reductions should be managed. This might take the form of controlling power to entire sections of a given network, down to activating or deactivating specific ports or links between selected network devices.

With continued reference to FIG. 1, the traffic monitor 106 takes the form of software that tracks data traffic usage throughout the network 110. In some specific examples, the traffic monitor 106 detects and tracks real-time data traffic through all branches of the network, identifying the traffic as a variety of parameters (data bandwidth, traffic efficiency, etc.). Other examples provide a logging function, where the traffic is monitored over a period of time to develop a history of traffic trends. Information relating to the real-time and historical trends may be stored in the memory resource by the network controller 102 for use by the power manager 108. In this way, the power manager 108 can provide a power control function reactively, such as in response to real-time traffic situations. The power manager 108 can also act proactively, in anticipation of expected traffic situations based on historical data detected and logged by the traffic monitor.

The power manager 108, like the traffic monitor 106, takes the form of software in one example. Following the high-level rules imposed by the network power policy 104, and taking advantage of the traffic information provided by the traffic monitor 106, the power manager 108 enforces the power policy through specified power criteria. For some examples, the criteria may involve macro usage parameters, such as a desired maximum wattage due to network device power consumption for an entire data center. In other examples, micro usage criteria may be defined, such as the number of active ports for a given network device, or active links interconnecting network devices. As used herein a “network device” may take the form of a switch, router, hub, bridge, access point, etc., e.g., a router having processor and memory resources and connected to a network. Combinations of macro and micro criteria may also be employed by the network controller 102. Variations of the power manager criteria and functionality are described more fully below.

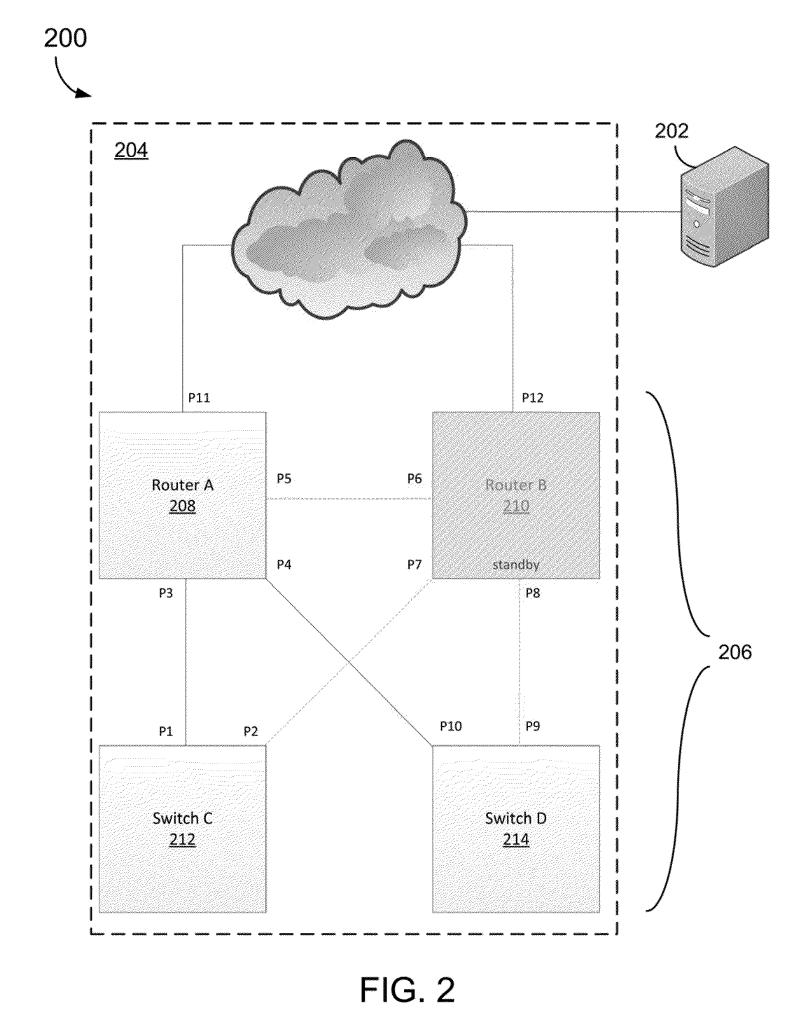

Referring now to FIG. 2, one example of a network, generally designated 200, is shown that includes a network controller 202, consistent with the controller 100 described above, that centrally manages power consumption of plural network devices 204 included within the network 200. For purposes of discussion, a portion 206 of the network is shown that employs a pair of routers, “Router A” 208 and “Router B” 210 that serve as backup routers to one another. A pair of Ethernet switches, “Switch C” 212 and “Switch D” 214 are also provided. Each switch includes respective ports P1, P2 and P9, P10 that are coupled to the respective routers 208 (via ports P3, P4) and 210 (via ports P7, P8). The routers 208 and 210 further include respective ports P11, P12 that couple to the remaining plural network devices 204, and ports P5, P6 that join the routers directly.

With one example of a network 200 shown in FIG. 2, in certain situations, it may be desirable for the network controller 202 to minimize power consumption from redundant network devices. With Router B 210 acting as a backup to Router A 208, one action the network controller 202 could take involves powering-down Router B 210. The effect would be to place the router in a low-power state, such as a standby mode. Standby mode involves significantly less power consumption than a normal active mode. While in standby mode, the router would still maintain a form of command communication functionality with the network controller 202 (such as through port P12), but the remaining ports associated with Router B would be powered-down (such as ports P6, P7, P8 and ports associated with the other network devices such as ports P5, P2 and P9), In addition to powering down network device ports, associated physical-layer devices (PHYs), media-access-controllers (MACs), application-specific-integrated-circuits (ASICs), blades, and other electronics associated with Router B 210 may be powered-down in order to save power.

Further referring to FIG. 2, with Router B 210 placed in a standby mode, the network controller 202 may continue to monitor that portion of the network for changes in data traffic usage. Should Router A 208 incur bursts of increased traffic through ports P11, P3 or P4, the network controller 202 may re-enable Router B 210 to an active state. The criteria for re-enabling may be based on pre-set thresholds for traffic capacity placed on the backup router, or other similar criteria.

With further reference to FIG. 2, in a situation where the network controller 202 powers-down both Router A and B, data traffic that would normally flow to downstream network devices would require re-routing through appropriately selected alternate network device paths. Such situations might result, for example, through implementation of a macro power management scenario involving powering-down, for example, an entire section of a data center during evening hours or other low network utilization period. This is a more involved situation to manage than, for example, merely powering down an edge port that doesn't require re-routing of data traffic. Thus, in some circumstances, power management decisions made by the network controller 202 may take into account the location of the network device in the overall network.

As a further example, and with continued reference to FIG. 2, the network controller 202 may choose to power-down one of the two switches Switch C 212 or Switch D 214. In some circumstances, virtual machines may be accessing the network through one of the switches. In case the virtual machine access is through a switch that is to be powered-clown, the network controller can migrate the virtual machine to another virtual machine server on a different switch.

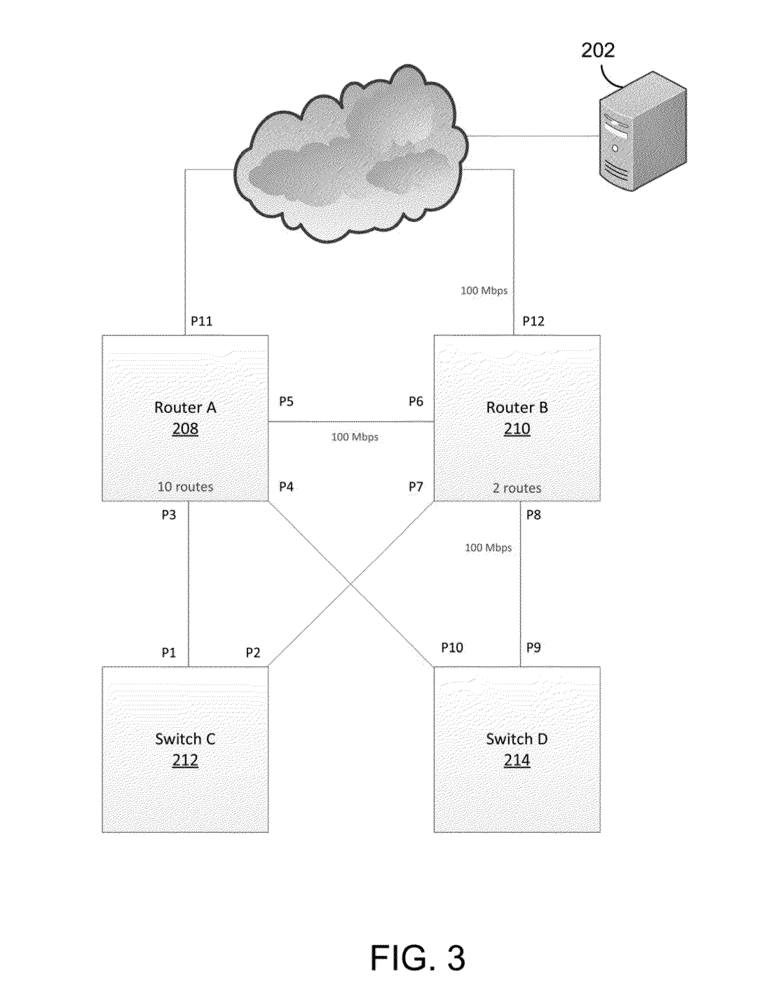

FIG. 3 illustrates the network of FIG. 2 with Router B 210 restored to an active state. While the network controller 202, in one example, might restore a default active state to Router B 210, in another example, the router might be brought back in a reduced role. For example, a port operating at a data rate of 10 Gbps consumes more power than a port running at 1 Gbps, and significantly more than a port operating at 100 Mbps. As a specific example, Routers A and B normally utilize six routes each. If Router B normally services six routes to the network 200, then the network controller could reduce that number to two routes while it drops its ports P6, P7 and P8 to 100 Mbps and moves the other four routes to Router A 208, which has its ports P3, P4 and P5 running at 1 Gbps. Router A would then be running ten total routes. This route distribution and re-balancing could be performed by the controller 202 based on data traffic load as monitored by the network controller traffic monitor 106 (FIG. 1).

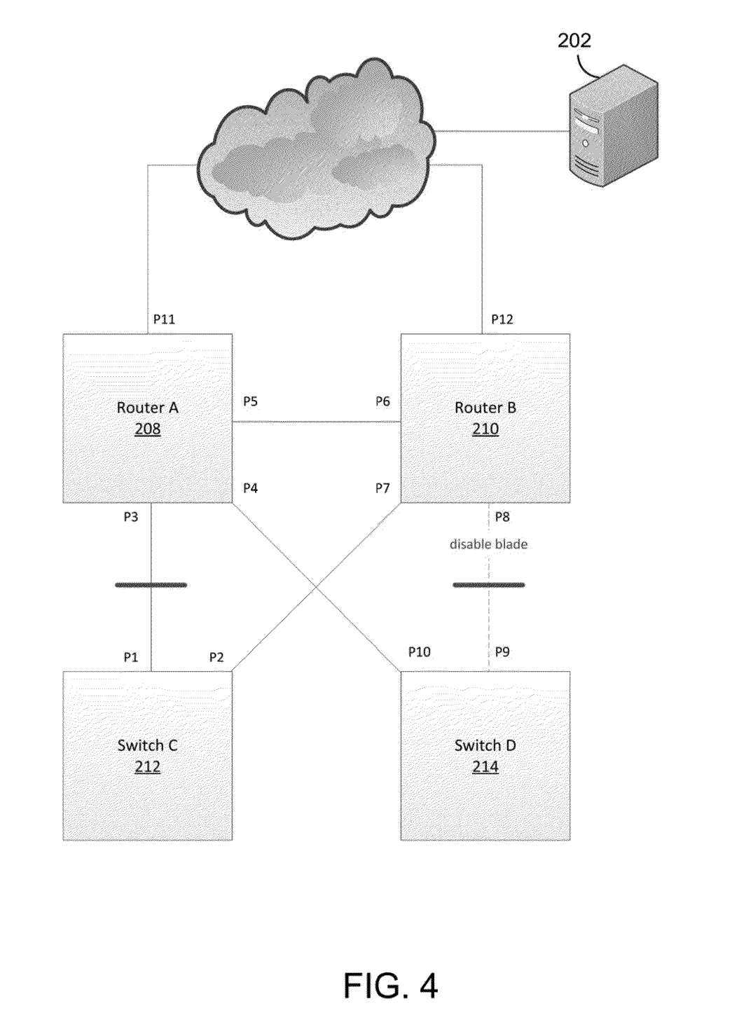

For some examples, the network controller 202 might also make informed decisions as to which ports should be disabled for a given network device based on where the ports reside on the switch. As an additional example, as shown in FIG. 4, with Router A taking a role as an STP root, port P7 is typically blocked between Router B 210 and Switch C 212 in an effort to avoid undesirable loops forming between the two backup routers. If port P8 for Router B resides on a different blade or sub-router (not shown) with no other ports enabled, then the network controller 202 could disable port P8 and its corresponding blade instead of port P7, thereby achieving the non-loop configuration, with an enhanced benefit of greater power savings. For such an example, Router A 208 would also need to change its port blocking scheme to port P3 rather than port P4.

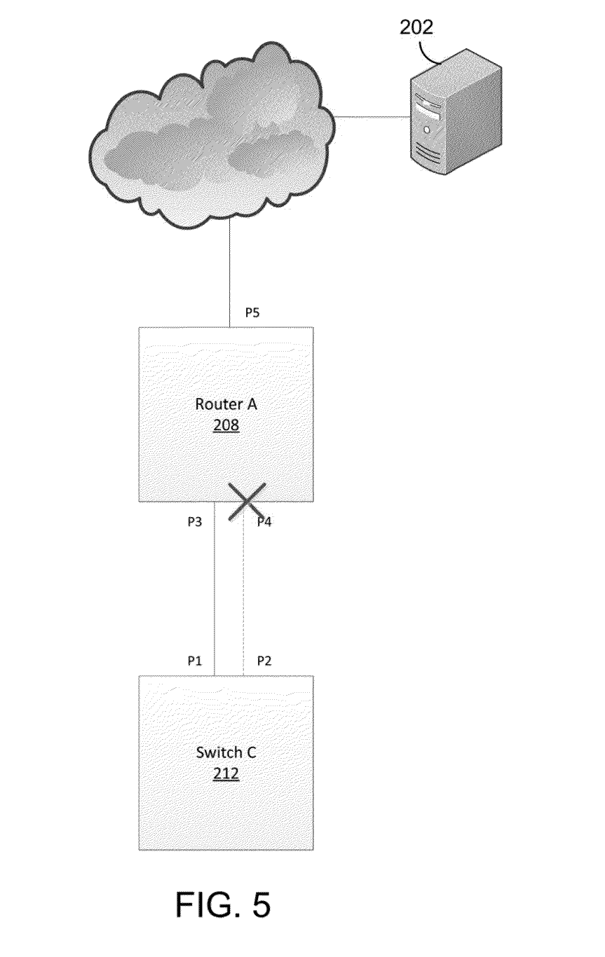

In some examples, a given link may be formed as a group of links aggregated together to achieve a desired data rate. Where links are employed as aggregated links, or experience periods of low utilization, it may be feasible for the network controller to take one or more links offline and place them in a standby mode to minimize power. FIG. 5 illustrates such a scenario. As traffic utilization increases, the controller may re-enable the link as needed and/or based on threshold data rate or power consumption criteria.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments even if the other features and embodiments make no mentioned of the particular feature. Thus, the absence of describing combinations should not preclude the inventor from claiming rights to such combinations.

What claimed is

1. A non-transitory computer-readable medium for managing power consumption in a network of network devices, the computer-readable medium storing instructions, that when executed by one or more processors, cause the one or more processors to perform operations comprising:
(a) monitor network data traffic;
(b) establish a network power management policy based on the monitored data traffic; and
(c) enforce the network power policy by centrally managing a powered state of a portion of the network based on power consumption criteria.

2. The non-transitory computer-readable medium of claim 1, wherein the power consumption criteria includes data rates through the network.

3. The non-transitory computer-readable medium of claim 1, wherein the power consumption criteria includes network usage based on time of day.

4. The non-transitory computer-readable medium of claim 1, wherein instructions for managing the powered state of portions of the network comprises configuring selected ports within selected network devices from a first powered state to a second powered state.

5. The non-transitory computer-readable medium of claim 1, wherein instructions for managing the powered state of portions of the network comprises configuring redundant data links from a first powered state to a second powered state.

6. The non-transitory computer-readable medium of claim 1, wherein instructions for centrally managing a powered state of portions of the network comprises:
powering-down at least one network device that forms a portion of at least one data path; and
redirecting data transferred on the first data path to avoid the powered-down network device.

7. The non-transitory computer-readable medium of claim 1, wherein instructions for monitoring network data traffic comprises storing a history of at least one from the group comprising data traffic patterns and data traffic utilization.

8. The non-transitory computer-readable medium of claim 6, wherein in a first mode, instructions for centrally managing a powered state comprises powering-down selected portions of the network, and in a second mode, instructions for centrally managing a powered state comprises powering-up selected network resources.

9. A network comprising:
a plurality of network devices; and
a network controller in communication with the network devices, the network controller including
a network traffic monitor, and
a power manager to control a powered state of a portion of the network based on information from the network traffic monitor and an established network power management policy.

10. The network of claim 9, wherein the power manager is operable to control a powered state of at least one of the network devices.

11. The network of claim 10, wherein the power manager is operable to control a powered state of at least a portion of at least one of the network devices.

12. The network of claim 9, wherein the power manager is operable to control a powered state of a link disposed between network devices.

13. The network of claim 9, wherein the power manager is operable to control the data rate of at least a portion of a network path.

14. The network of claim 9 embodied as a software driven network (SDN).

15. A network controller for controlling a software driven network comprising:
a network data traffic monitor; and
a power manager configured to control a powered state of a portion of the network based on information from the network traffic monitor and an established network power management policy.
